(19) United States
(12) Patent Application Publication
(10) Pub. No.: US 2022/0162512 A1
(43) Pub. Date: May 26, 2022

(54) Melt-flowable extracts from biomass as a selective additive for agglomerated biomass with binding and moisture resistance properties

(71) Applicant: Regents of the University of Minnesota, Minneapolis, MN (US)

(72) Inventors: Timothy Hagen, Superior, WI (US); Matthew Young, Duluth, MN (US); Donald Fosnacht, Hermantown, MN (US); Eric Singsaas, Duluth, MN (US)

(21) Appl. No.: 17/441,139

(22) PCT Filed: Mar. 16, 2020
(86) PCT No.: PCT/US2020/022961

§ 371 Date: Sep. 20, 2021

Related U.S. Application Data
(60) Provisional application No. 62/821,792, filed on Mar. 21, 2019.

(51) Int. Cl. C10L 5/44; C10L 9/08; C10L 5/08; C10L 5/36

(52) U.S. Cl. CPC C10L 5/44; C10L 9/083; C10L 9/086; C10L 5/447; C10L 2200/0469; C10L 5/361; C10L 5/363; C10L 2290/24; C10L 2290/30; C10L 5/08

(57) ABSTRACT

A method for producing an agglomerated solid bio-material comprises providing a particulate torrefied wood mass or a comminuted wood mass and blending with a particulate melt-flowable extract (MFE) recovered from an organosolv pulping process. The particulate torrefied biomass or the comminuted biomass is blended with the MFE to form a blended mixture wherein the particulate torrefied bio-mass or the comminuted wood mass is the primary component. The blend is agglomerated under pressure at a temperature of at least approximately 38° C. (100° F.) to form the agglomerated solid material which exhibits hydrophobic characteristics.

### BACKGROUND

The present disclosure relates to pelleting or forming briquettes from particulate biomass utilizing a binder made from a melt-flowable extract (MFE) of biomass.

Raw biomass is a potential source of renewable carbon-based energy. Presently, other forms of energy such as coal, oil, and natural gas are typically used to generate heat or electricity or both. Due to its low volumetric energy density and poor durability, biomass fuels need to be processed by agglomeration, densification, or other means be a viable commercial energy and fuel replacements.

Presently, raw biomass such as wood is ground up and made into pellets, for example in use for pellet burning stoves. Charcoal briquettes are also available as a fuel source and commonly used for cooking. For a number of reasons, there is still a need for producing a solid biofuel agglomerated product that can be stored outside, that has a high bulk density for ease of logistical transportation, has good handling characteristics that minimize dust generation, grindability that is similar to coal used in power plants, and has fuel content that matches or exceeds sub-bituminous coal levels.

Torrefication is a treatment technology for concentrating the energy content of raw biomass, such as wood. However, torrefied materials have proven to be difficult to densify using various densification equipment. Uniformly torrefied materials at high energy levels appear to be especially difficult to densify but have attributes of high fuel value and good grindability.

### SUMMARY

This disclosure includes a method for producing an agglomerated solid bio-material having water resistance and mechanical durability. The method comprises providing a particulate torrefied wood mass or a comminuted white wood and providing an extract recovered from an organosolv pulping process that is melt-flowable. The particulate torrefied wood mass or comminuted white wood are blended with the melt-flowable extract to form a blended mixture wherein the particulate torrefied wood mass or comminuted wood is the primary component. The blended mixture is agglomerated under pressure at a temperature of at least approximately 38° C. (100° F.) to form the agglomerated solid material.

In another embodiment, the agglomerated solid material can be in the form of a pellet or a briquette. Other forms such as bricks, logs, balls can also be formed from the admixtures.

In another embodiment, the particulate torrefied wood mass or the comminuted wood mass comprises approximately 70 to 90% by weight of the blended mixture.

In another embodiment, the melt flowable extract exhibits hydrophobic characteristics.

In another embodiment, the densification occurs in a pellet mill and the agglomerated material comprises pellets.

In another embodiment, the agglomerated solid biomass comprises torrefied wood and an extract content of between approximately 5 to 30%.

In another embodiment, the extract exhibits hydrophobic characteristics and provide such characteristics to the agglomerated solid material.

In another embodiment, agglomerated wood mass comprises a wood component, and an extract from an organosolv process wherein the wood comprises approximately 1 to 40% of the agglomerated wood mass.

In another embodiment, the melt-flowable extract of the agglomerated wood mass exhibits hydrophobic characteristics and provides such characteristics to the agglomerated wood mass as a whole.

In another embodiment, the agglomerated wood mass is either a pellet or a briquette. Although other forms such as bricks, logs and balls can also be considered.

In another embodiment, the wood component is torrefied wood. Other non-woody biomass such as herbaceous and agricultural materials can be torrefied and used.

In another embodiment, the melt flowable extract comprises approximately 1 to 40% of the agglomerated wood mass.

### BRIEF DESCRIPTION OF THE DRAWINGS

FIG. 1 is a graphical view of the particle sizes of raw materials used in this disclosure.

FIG. 2 is a graphical view of the average tumbling durability of pellet formulations.

FIG. 3 is a graphical view of the average water uptake of white wood tobacco extract pellets.

FIG. 4 is a graphical view of the average water uptake of torrefied wood tobacco extract pellets.

FIG. 5 is a graphical view of the average water uptake of the various pellet formulations after 24 hours.

FIG. 6 is a photographic view of 100% pine wood pellets.

FIG. 7 is a photographic view of 100% pine wood pellets after 24 hours of immersion.

FIG. 8 is a photographic view of 100% pine wood pellets after 24 hours of water immersion.

FIG. 9 is a photographic view of 90% Pinewood/10% tobacco extract pellets.

FIG. 10 is a photographic view oh 90% Pinewood/10% tobacco extract pellets after 24 hours of water immersion.

FIG. 11 is a photographic view 90% pine wood/10% tobacco extract pellets after 24 hours of water immersion.

FIG. 12 is a photographic view 80% Pinewood/20% tobacco extract pellets.

FIG. 13 is a photographic view 80% Pinewood/20% tobacco extract pellets after 24 hours of water immersion.

FIG. 14 is a photographic view of 80% Pinewood/20% tobacco extract pellets after 24 hours of water immersion.

FIG. 15 is a photographic view of 70% pine wood/30% tobacco extract pellets.

FIG. 16 is a photographic view of 70% Pinewood/30% tobacco extract pellets after 24 hours of water immersion.

FIG. 17 is a photographic view 70% pine wood/30% tobacco extract pellets after 24 hours of water immersion.

FIG. 18 is a photographic view 90% torrefied wood/10% tobacco extract pellets.

FIG. 19 is a photographic view of 90% torrefied wood/10% tobacco extract pellets after 24 hours of water immersion.

FIG. 20 is a photographic view of 90% torrefied wood/10% tobacco extract pellets after 24 hours of water immersion.

FIG. 21 is a photographic view up 80% torrefied wood/20% tobacco extract pellets.

FIG. 22 is a photographic view 80% torrefied wood/20% tobacco extract pellets after 24 hours of water immersion.

FIG. 23 is a photographic view 80% torrefied wood/20% tobacco extract pellets after 24 hours of water immersion.

FIG. 24 is a graphical view of the average absolute density of the pellet formulations.

### DETAILED DESCRIPTION

This disclosure relates to an improved method of densifying white wood or torrefied wood to produce water resistant and mechanically durable pellets or briquettes. The method uses a hydrophobic biomass-based binder produced by an organosolv process. The extract has very low sulfur and sodium content and high calorific value. The pellets or briquettes are high quality bonded substrates that are durable. Although pellets and briquettes are specifically mentioned herein, other forms of agglomerated matter are included within this disclosure such as sheets, wafers, logs, bricks, balls, or contoured shapes

In addition, the binder of this disclosure imparts hydrophobic properties to the pellets or briquettes making the pellets and briquettes moisture resistant. In addition, higher fixed carbon biomass products are difficult to densify, and so a melt flowable extract binder is necessary to create a granulated or durable product. The binder of this disclosure may also be used not only for pelleting white wood or torrefied wood but also in applications as a binder for production of liquid biofuels, solid biofuels, syngas, biochar, kitty litter, activated carbon, metallurgy, plastic compounding fillers, soil amendments, fertilizers, water treatment chemicals and media, and supplemental agricultural feed additives.

For purposes of this application and as used herein the term “melt-flowable extract” (MFE), or simply extract, shall mean a product extracted from biomass using heat, pressure, and an organic solvent. This extract is largely comprised of neutral lignin (>85%) and may contain trace amounts of carbohydrates, solvent, furfural, and resins. This product is distinct from kraft lignin and lignosulfonates in that it softens and melts into a flowable product at temperatures between about 80-190° C. (176-374° F.) and is mostly hydrophobic. It is distinct from hydrolysis lignin in that it does not contain cellulose fibers.

The MFE used in the method of this disclosure is extracted via what is commonly known as an organosolv process that extracts the lignin with a water insoluble, or hydrophobic solvent. The extract of this disclosure is in contrast to the kraft or sulfite pulping process that removes lignin from the cellulose fibers by treatment with sodium hydroxide, sodium sulfide, or salts of sulfuric acid as a predicate to papermaking. Such lignin is not suitable for the method and pellets or briquettes described herein.

More specifically, the extract of this disclosure is extracted using preferably butanol, although other hydrophobic solvents, including esters such as butyl acetate, ethyl acetate may also be used. Ethylene glycol and ethanol are known as lignin extractants but are not suitable for the method of this disclosure due to their hydrophilic characteristics. Lignin extraction processes useful in the method of this disclosure are described in U.S. Pat. Nos. 8,465,559, 8,211,189 and 9,365,525.

The extract source may be any suitable biomass. As specifically disclosed herein, tobacco is a preferable source for lignin extract suitable for the method of this disclosure to form the moisture resistant pellets and briquettes. However, other extracts have been found suitable that were extracted from southern yellow pine, hybrid poplar, and mixed hardwood wood chips utilizing the organosolv process described herein. It is believed that other biomass sources from which lignin may be extracted using an organosolv process are within this disclosure.

The MFE of this disclosure is blended with either a comminuted wood source or a torrefied wood. Since the extract used herein is typically a dry powder, it is preferred that the comminuted wood source or a torrefied wood is of a suitable particle size to blend well with the extract. One preferred ratio of extract to comminuted wood source or a torrefied wood is approximately 5 to 10% extract to 95 to 90% the comminuted wood source or a torrefied wood; the ratio of extract to wood or torrefied wood is based on the dry weight of each material. Another preferred range of material blends is approximately 10/90% to 30/70% of extract to torrefied wood. MFE content as low as approximately 5% has been found to be suitable with little loss of properties in the agglomerated pellet or briquette. It is also believed that an extract content as low as approximately 1% would also be suitable depending on the wood component and the processing conditions for forming the agglomerated product. The blended mixture of extract and comminuted wood source or a torrefied wood is then processed through a pelletizer. Preferably the pelletizer has been preheated to at least 38° C. (100° F.) thereby forming pellets.

The term white wood as used herein is a wood that has not been subjected to heat treatment and has been comminuted to a selected particle size. The wood can be a soft wood or a hardwood.

Torrefied biomass may comprise wood dust, ground wood, agricultural waste dust, ground agricultural waste, torrefied and ground biomass, hydrothermal carbonized and ground biomass, dried algae, charred biomass by thermal processing or combinations thereof.

The term torrefied wood as used herein is material made by a thermochemical treatment of biomass at 200 to 350° C. (392 to 662° F.) with a fixed carbon content of 25-60% and an energy content ranging from 20,236 kJ kg⁻¹ (8,700 btu/lb.) to 27,912 kJ kg⁻¹ (12,000 btu/lb.). The treatment is carried out under atmospheric pressure and in the absence of oxygen. During the torrefaction process, the water contained in the biomass as well as superfluous volatiles are released, and the biopolymers (cellulose, hemicelluloses and lignin) partly decompose. The final product is a solid, dry, brownish to blackened material.

The term biochar as used herein is a material made by thermochemical treatment of biomass at 350-650° C. (662-1202° F.) with a fixed carbon content of greater than 60%, hydrogen:carbon ratio less than 0.7 and an oxygen:carbon ratio less than 0.4. The biochar can be made from hardwood, softwood, grasses, other agricultural or herbaceous materials, forbs or algae.

### EXAMPLES

### Example 1: White Wood (Pine) and Tobacco Extract Pelleting

In this example, 3 different blends of white wood (pine) and forb (tobacco) extract were combined to form pellets.

The material preparation for all three blends was as follows:

1) The white wood was hammermilled (using a Jay Bee Hammermill, serial no. 11463, size: 3B—Plain, catalog no. 29141, max rpm: 3600) with a ¼″ (0.635 mm) screen installed.
2) The (dried to less than 10% moisture) pine wood was sieved for 5 minutes (using a Ro-Tap RX-29 Test Sieve Shaker) into seven mesh sizes: +8 (2.38 mm), +16 (1.19 mm), +20 (0.841 mm), +30 (0.595 mm), +40 (0.42 mm), +50 (0.297 mm), and −50. See FIG. 1 for particle distribution.
3) Solid tobacco lignin extract previously made via an organosolv process utilizing butanol was first chipped by hand to nominally sized chipstock 12.7 mm (½″) and then ground to a fine powder in a rotating ball mill (using a U.S. StoneWare Rotary Ball Mill, serial no. CV-87203).
4) The tobacco extract having been dried to less than 10% moisture was sieved for 5 minutes (using a Ro-Tap RX-29 Test Sieve Shaker) into seven mesh sizes: +8, +16, +20, +30, +40, +50, and −50. See FIG. 1 for particle distribution.

First Blend:

The material for the first blend was pine white wood and tobacco extract in ratios (dry weight) of 90% pine wood and 10% tobacco extract.

The material blend was pelleted with the following steps:

1) A mixture consisting of 90% hammer-milled pine wood (based on dry weight of mixture) and 10% powdered tobacco extract (based on dry weight of mixture) was mixed in a Hobart Mixer for 2-5 minutes with the water added until a pellet can be formed that meets durability standards (typically approximately 4-20% water on a wet weight basis).
2) The final moisture content of the mixture was determined to be 14.2%.
3) The blend was then poured into a hopper on a 3 HP, 60 Hz, 230 V, Model No. 384640, CPM (California Pellet Mill Co.) pellet mill. The pellet mill was fitted with a die with a compression ratio of 5 (compression ratio=pellet hole length/pellet hole diameter). The pellet size produced was ¼″ (0.635 mm) in diameter. The pellet die was preheated to at least 100° F. (38° C.) with various biomass prior to adding the blend.
4) The 90% pine wood/10% tobacco extract blend was then fed into the preheated die at the appropriate rate to prevent overloading the motor and under-loading the die holes.
5) Temperatures were monitored of the exiting pellets and once the pellet performance had been optimized and reached steady state samples were collected.
6) The steady state exit temperature of the pellets for this blend was 49-71° C. (120-160° F.).
7) Pellets were then allowed to cure for at least 24 hours before subsequent testing was performed.

Second Blend:

The material for the second blend was pine white wood and tobacco extract in ratios (dry weight) of 80% pine wood and 20% tobacco extract.

The material blend was pelleted with the following steps:

1) A mixture consisting of 80% hammer-milled pine wood (based on dry weight of mixture) and 20% powdered tobacco extract (based on dry weight of mixture) was mixed in a Hobart Mixer for 2-5 minutes with the appropriate amount of water added until a pellet can be formed that meets industry durability standards (typically approximately 4-20% moisture on a wet weight basis).
2) The final moisture content of the mixture was determined to be 14.9%.
3) The blend was then poured into a hopper on a 3 HP, 60 Hz, 230 V, Model No. 384640, CPM (California Pellet Mill Co.) pellet mill. The pellet mill was fitted with a die with a compression ratio of 5 (compression ratio=pellet hole length/pellet hole diameter). The pellet size produced was 0.635 mm (¼″) in diameter. The pellet die was preheated to at least 38° C. (100° F.) with various biomass prior to adding the blend.
4) The 80% pine wood/20% tobacco extract blend was then fed into the preheated die at the appropriate rate to prevent overloading the motor and under-loading the die holes.
5) Temperatures were monitored of the exiting pellets and once the pellet performance had been optimized and reached steady state samples were collected.
6) The steady state exit temperature of the pellets for this blend was 38-77° C. (100-170° F.).
7) Pellets were then allowed to cure for at least 24 hours before subsequent testing was performed.

Third Blend:

The material for the third blend was pine white wood and tobacco extract in ratios (dry weight) of 70% pine wood and 30% tobacco extract.

The material blend was pelleted with the following steps:

1) A mixture consisting of 70% hammer-milled pine wood (based on dry weight of mixture) and 30% powdered tobacco extract (based on dry weight of mixture) was mixed in a Hobart Mixer for 2-5 minutes with the appropriate amount of water added until a pellet can be formed that meets industry durability standards (typically 4-20% moisture on a wet weight basis).
2) The final moisture content of the mixture was determined to be 13.2%.
3) The blend was then poured into a hopper on a 3 HP, 60 Hz, 230 V, Model No. 384640, CPM (California Pellet Mill Co.) pellet mill. The pellet mill was fitted with a die with a compression ratio of 3 (compression ratio=pellet hole length/pellet hole diameter). The pellet size produced was 0.635 mm (¼″) in diameter. The pellet die was preheated to at least 38° C. (100° F.) with various biomass prior to adding the blend.
4) The 70% pine wood/30% tobacco extract blend was then fed into the preheated die at the appropriate rate to prevent overloading the motor and under-loading the die holes.
5) Temperatures were monitored of the exiting pellets and once the pellet performance had been optimized and reached steady state samples were collected.
6) The steady state exit temperature of the pellets for this blend was 32-54° C. (90-130° F.).
7) Pellets were then allowed to cure for at least 24 hours before subsequent testing was performed.

### Example 2: Torrefied Wood (Torrefied Ponderosa Pine) and Extract Pelleting

In this example, 2 different blends of torrefied wood and tobacco extract were combined to form pellets.

The material preparation for both blends was as follows:

1) Torrefied ponderosa pine for this example was generated at the NRRI-Biomass Conversion Lab located in Coleraine, Minn. This torrefied wood had a calorific value of 22,312 LI kg⁻¹ (9,613 BTU/lb.) with a range most likely of +/−˜700 kJ kg⁻¹ (˜300 BTU/lb). The Biomass Conversion Lab used a rotary kiln set at various temperatures with an inert atmosphere to torrefy the Ponderosa pine.
2) The torrefied wood was ground using an opposing face plate grinder with an attached 0.5 HP, 90 V motor.
3) The torrefied wood was dried to less than 10% moisture and was sieved for 5 minutes (using a Ro-Tap RX-29 Test Sieve Shaker) into seven mesh sizes: +8 (2.38 mm), +16 (1.19 mm), +20 (0.841 mm), +30 (0.595 mm), +40 (0.42 mm), +50 (0.297 mm), and −50. See FIG. 1 for particle distribution.
4) The tobacco extract was ground to a fine powder (see FIG. 1) in a rotating ball mill (using a U.S. StoneWare Rotary Ball Mill, serial no. CV-87203).
5) The tobacco extract was dried to less than 10% moisture and was sieved for 5 minutes (using a Ro-Tap RX-29 Test Sieve Shaker) into seven mesh sizes: +8, +16, +20, +30, +40, +50, and −50. See FIG. 1 for particle distribution.

First Blend:

The material for the first blend was torrefied wood and tobacco extract in ratios (dry weight) of 90% torrefied wood and 10% tobacco extract.

The material blend was pelleted with the following steps:

1) A mixture consisting of 90% torrefied wood (based on dry weight of mixture) and 10% powdered tobacco extract (based on dry weight of mixture) was mixed in a Hobart Mixer for 2-5 minutes with the appropriate amount of water added.
2) The final moisture content of the mixture was determined to be 14.6%.
3) The blend was then poured into a hopper on a 3 HP, 60 Hz, 230 V, Model No. 384640, CPM (California Pellet Mill Co.) pellet mill. The pellet mill was fitted with a die with a compression ratio of 2 (compression ratio=pellet hole length/pellet hole diameter). The pellet size produced was 0.635 mm (¼″) in diameter. The pellet die was preheated to at least 38° C. (100° F.) with various biomass prior to adding the blend.
4) The 90% torrefied wood/10% tobacco extract blend was then fed into the preheated die at the appropriate rate to prevent overloading the motor and under-loading the die holes.
5) Temperatures were monitored of the exiting pellets and once the pellet performance had been optimized and reached steady state samples were collected.
6) The steady state exit temperature of the pellets for this blend was 38-54° C. (100-130° F.).
7) Pellets were then allowed to cure for at least 24 hours before subsequent testing was performed.

Second Blend:

The material for the second blend was torrefied wood and tobacco extract in ratios (dry weight) of 80% torrefied wood and 20% tobacco extract.

The material blend was pelleted with the following steps:

1) A mixture consisting of 80% torrefied wood (based on dry weight of mixture) and 20% powdered tobacco extract (based on dry weight of mixture) was mixed in a Hobart Mixer for 2-5 minutes with the appropriate amount of water added.
2) The final moisture content of the mixture was determined to be 13.2%.
3) The blend was then poured into a hopper on a 3 HP, 60 Hz, 230 V, Model No. 384640, CPM (California Pellet Mill Co.) pellet mill. The pellet mill was fitted with a die with a compression ratio of 2 (compression ratio=pellet hole length/pellet hole diameter). The pellet size produced was 0.635 mm (¼″) in diameter. The pellet die was preheated to at least 38° C. (100° F.) with various biomass prior to adding the blend.
4) The 80% torrefied wood/20% tobacco extract blend was then fed into the preheated die at the appropriate rate to prevent overloading the motor and under-loading the die holes.
5) Temperatures were monitored of the exiting pellets and once the pellet performance had been optimized and reached steady state samples were collected.
6) The steady state exit temperature of the pellets for this blend was 38-49° C. (100-120° F.).
7) Pellets were then allowed to cure for at least 24 hours before subsequent testing was performed.

Test Procedures for Product Produced in Examples 1 and 2:

The pine wood/tobacco extract and torrefied wood/tobacco extract pellets were tested for performance using the procedures described below:

The pellets samples were also sent to a certified lab (Twin Ports Testing, Superior, Wis.) for proximate fuel analysis.

The absolute density was measured for all pellet samples.

Tumbling durability was performed using a Kansas State Tumbling Can apparatus (ASAE Standard S269.5—Pellet Durability Test)

1) First, the diameter of the pellets was used to determine the appropriate test screen size.
2) Samples (500 g or 1.1 lb.) (prescreened on test sieve (5.66 mm, 0.223 inch mesh size) for 2 minutes to remove fines) were taken from the sample set and tumbled for 10 minutes at the standard rate of 50 revolutions per minute.
3) After 10 minutes, the sample was removed, placed on the test sieve (5.66 mm, 0.223 inch mesh size), sieved for 2 minutes, and the amount of material retained was weighed.
4) Percent durability was determined using the following formula:

((Final Mass)/(Initial Mass))*100%

The minimum durability value is set by the pellet industry at 98.0%. The Kansas State Tumbling Can test provides a way to quantitatively measure durability so that a value can be used to ensure that pellets are durable enough for material handling and transportation with minimal dust generation.

Water uptake was determined by a 24-hour submersion test.

1) The initial mass of the pellets was determined using an OHAUS gram scale: AR5120.
2) Pellets were submerged using nets that all had the same mesh size in water in a beaker.
3) Pellets were removed from the beaker at specific time periods, placed on a paper towel where the surface moisture wicked off for 1-3 minutes. The mass was then determined. This was done at five different time points: 0 minutes, 15 minutes, 1 hour, 3 hours, and 24 hours. A decrease in mass at longer time periods corresponds to substantial disintegration of the pellets.
4) Percent moisture uptake was determined at each time point, using the following calculation: (((Final Mass−Initial Mass))/Initial Mass)*100%
5) Photographs were taken of the pellets after 24 hours of immersion to document the pellet structure and note any disintegration.

Water uptake of 30% of initial pellet mass is internally noted as a failure as this would be unacceptable in the current commercial fuel market. Also, it must be noted that 24 hours of water immersion is a harsh condition meant to test pellets in an environment with substantial rainfall. The rate of absorption is also a factor as after 24 hours pellets may absorb more than 30% of their mass in water but after 3 hours may still have absorbed less than 30% indicating they would be suitable in some climates. Most importantly, this test is used comparatively to determine if hydrophobicity is more prominent in some pellets compared to others.

Commercial white wood pellets (composed of various wood types) were used as controls for this test.

C) Absolute Pellet Density Test:

1) The density (g cm⁻³) of each blend of pellets (Examples 1 and 2) was determined by selecting pellets produced during steady state and measuring their mass, length, and diameter. The measurements were taken after permitting the pellets to cure for at least 24 hours. The density was computed from the mass and volume.
Commercial white wood pellets (composed of various wood types) were used as controls for this test.

D) Proximate Analysis Test:

Proximate fuel analysis (conducted by Twin Ports Testing) was done to determine the ratio of the following substances within the pellets:

### a) Moisture

### b) Ash

c) Volatile matter
d) Fixed carbon by difference

### e) Sulfur

### f) SO₂

The high heating value (HHV) of the pellets was also determined.

Summary of Findings:

A) Pelleting Process:

The observed characteristics of the pelleting process in the Examples 1 and 2 are related to the small (3 HP) ring and die lab pellet unit only. Commercial pelletizers with larger ring and die units may behave somewhat differently than a lab pellet unit and will have more horsepower (allowing a higher compression ratio die to be used), different heat gradients and cooling capacities, etc.

The tobacco derived extract used in Examples 1 and 2 plasticized under heat and recrystallized after cooling.

1) White Wood and MFE:

The melt flowable extract (MFE) naturally breaks into a fine powder due to its brittle nature (see FIG. 1, Particle Distributions); this allowed the extract powder to be uniformly mixed and adhere to the white wood prior to pelleting. Overall, the MFE did not impede pelleting. This is crucial from a commercial aspect as pelleting white wood is already optimized in the pelleting industry. Because the extract gains plasticity as it is heated, it starts to flow before contacting the die. If there is then any opportunity to cool slightly before the die, shark skinning, caking or layering becomes evident in the die interface, indicating that the melt flow properties were sub-optimal prior to densification. It is critical that the extract gain the proper melt flow properties, just as it enters the die and as it exits it is allowed to cool, appropriately. The “caking” and layering indicates that the temperature should be confined to within a particular range to prevent the extract from plasticizing too far and building up in the die chamber and feed area. A pellet compression ratio of 3 (lower than the 5 used for the other mixtures) was used when 30% extract was included to allow pellets to be ejected more quickly from the die (higher compression ratio=increase in die hole length and increase in the frictional area) to prevent this plasticizing problem from occurring; the compression ratio does not necessarily reflect the ease of pelleting as this mix pelleted just the same as other blends.

In this application the MFE significantly reduces the proportion of fines that are generated at the pellet mill. The melt flow properties of the MFE adheres to and significantly pre-agglomerates the fines just before entering the die hole, thereby creating less fines as the pellets exit the mill.

2) Torrefied Wood and Extract:

Due to having a lower amount of natural lubricants (such as extract) and due to the more brittle nature of torrefied wood, torrefied wood has historically been extremely difficult to pellet. The material traits also cause the torrefied wood to plug in the die with larger die sizes (such as ¼″) due to inter-particle inter-locking in the die holes and higher surface friction compared to white wood. However, with the inclusion of extract and the plastic nature of the extract binder, it was discovered that a low compression ratio (a C.R. of 2 in this case) allowed the material to be ejected from the die without plugging and free of fines. In the past this compression ratio (C.R. of 2) has also been successful (die did not plug) with torrefied wood but the pellet quality was decreased as only “discs” or plates of pellets would be produced with substantial fines, not the elongated/strong pellets observed with the extract. The plastic nature of the extract bound the torrefied wood and also appeared to lubricate it as it was pushed through the die hole which prevented a large temperature increase in the pellet mill. This extract lubrication may be beneficial down the road as temperature control will be crucial when pelleting with the extract.

In this application the throughput and productivity of a low compression ratio die is likely significantly greater than a higher compression ratio die. This, in addition to less fines generated at the mill, may unleash significant productivity increases currently unheard of in the pelleting industry and allow the MFE to penetrate existing and emerging markets.

B) Durability Tests:

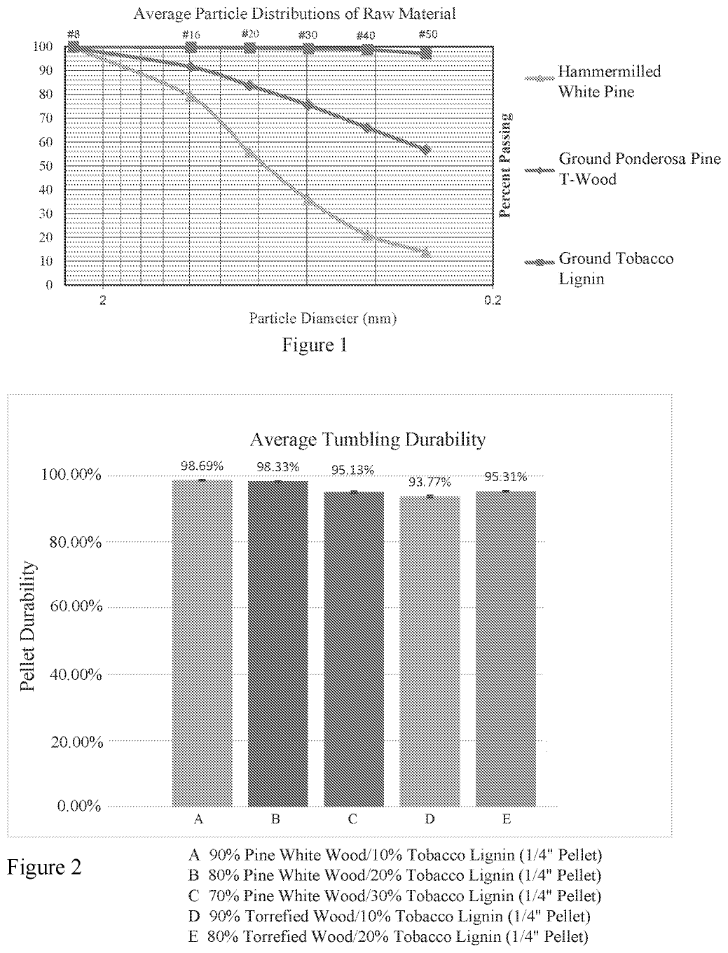

FIG. 2 displays the average tumbling durability of the various pellet formulations. The results were used for comparison between samples as a higher compression ratio die (with a larger horsepower pellet mill) will increase durability. The results show that the white wood and extract pellet blends produced with a compression ratio of 5 (10 and 20% extract inclusion) garnered a durability value over 98% (meeting industry standards and indicating the extract did not inhibit the ability to create durable white wood pellets). The pine/extract blend at 30% extract used a compression ratio 3 die due to upstream pelleting issues and therefore the durability decreased to 95%.

The torrefied wood and extract blends show that an increase in extract increases the durability of the pellets. The durability value went from 93.77% to 95.31% as the extract level went from 10 to 20%. Torrefied wood is brittle in nature and is known to mechanically disintegrate easily so it is obvious that the cooling and crystallization of the extract polymers after pellet curing created more durable pellets.

Note: A control sample of white wood pellets was not included as they were assumed to yield a durability value over 98%.

C) Water Uptake Tests:

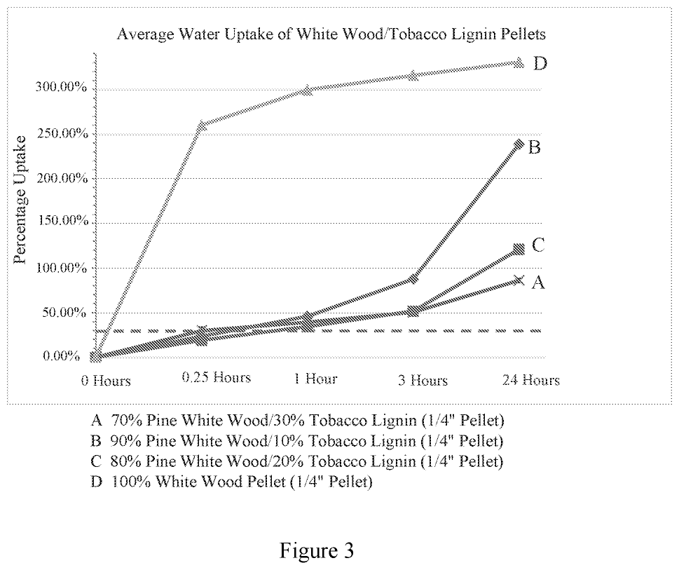

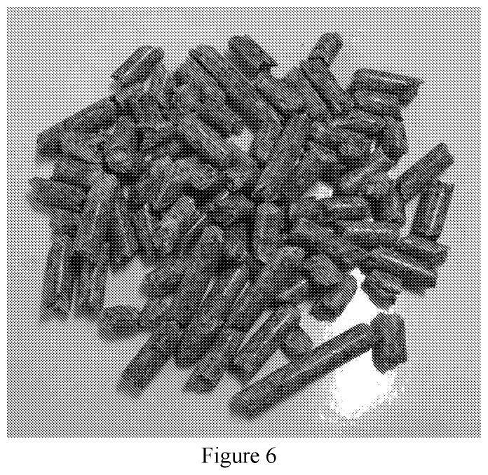

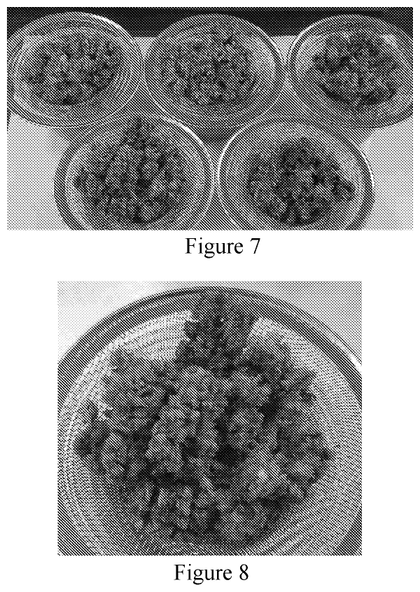

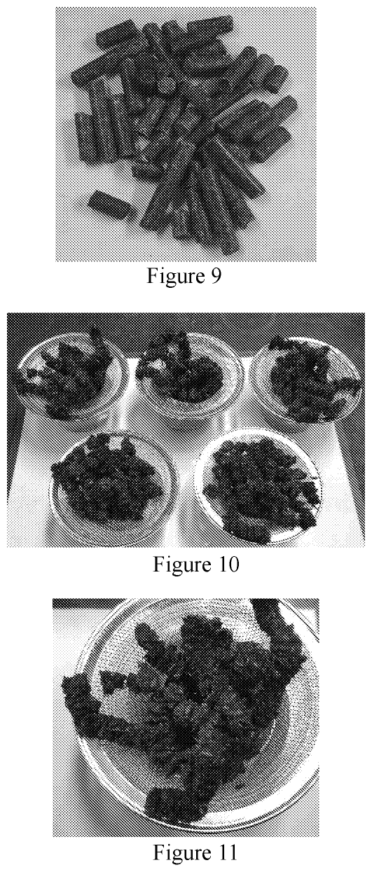

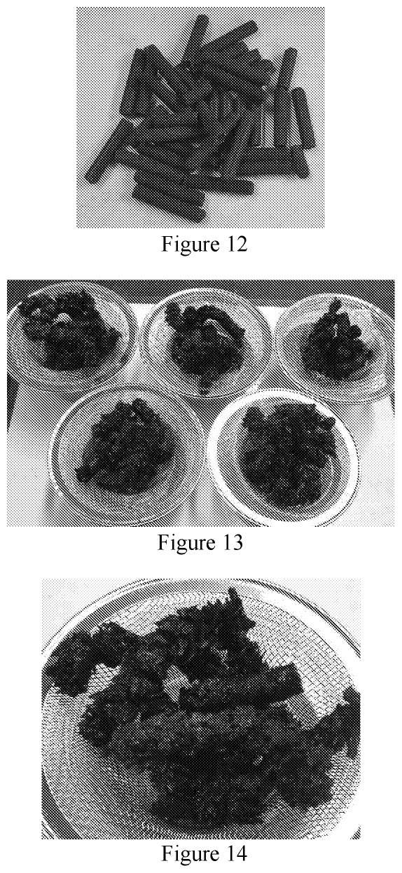

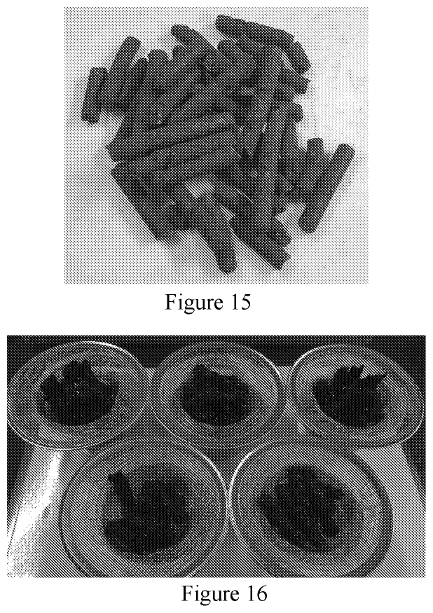

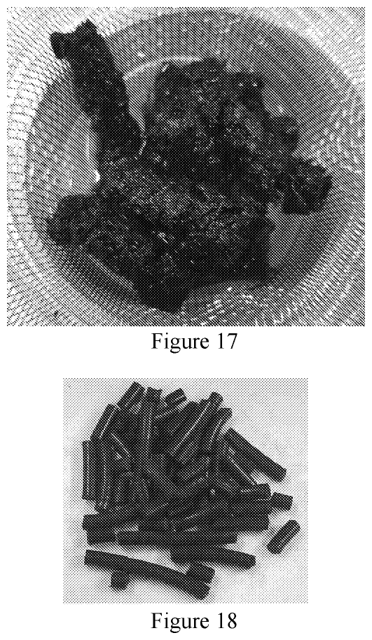

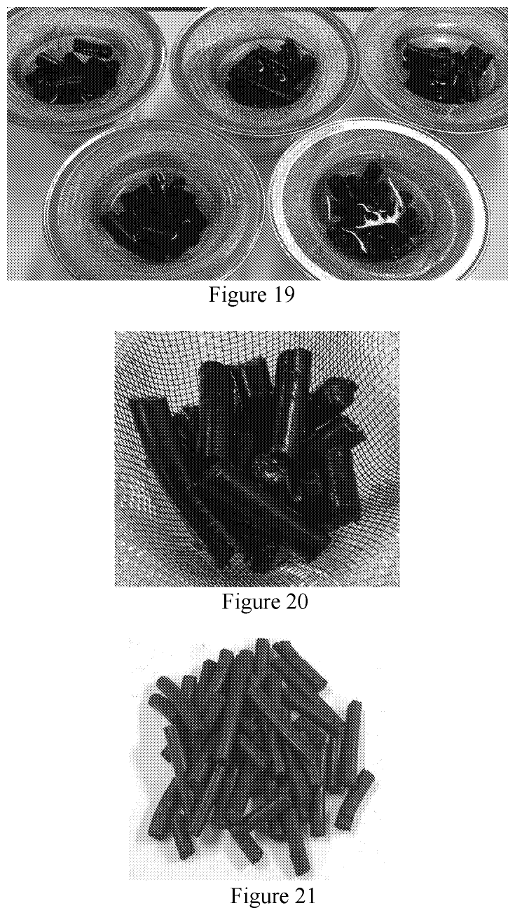

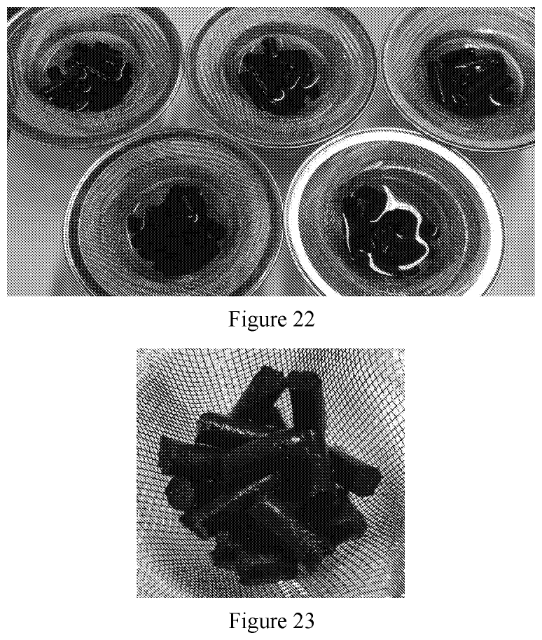

FIGS. 3-5 give a quantitative assessment of the moisture resistance of the pellet blends and FIGS. 6-23 give a qualitative assessment with photographs of the samples after 24 hours of immersion. White wood pellets are hydroscopic and immediately absorb moisture within the 15 minute parameter (see 100% white wood pellet data in FIGS. 3-5 where over 250% of initial mass was absorbed) which is well known in industry. However, all pellet blends with extract (10-30% inclusion) were prevented from absorbing over 30% of their mass within the first 15 minutes. After the 15-minute mark the pellets separated in their degree of moisture uptake with the amount of binder being inversely proportional to the amount of water absorbed (more extract/less water).

FIGS. 6-17 also visually imply that as extract binder increases so does the ability of the pellets to retain their shape and not “popcorn” (expand) out as seen with 100% white wood pellets after 24 hours.

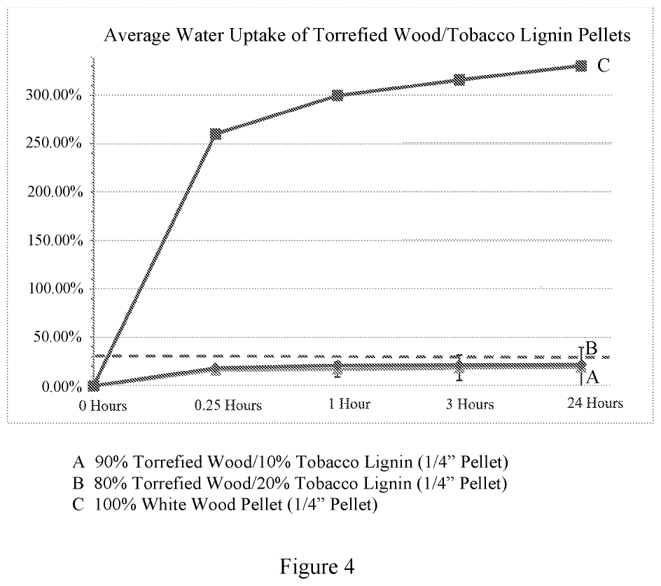

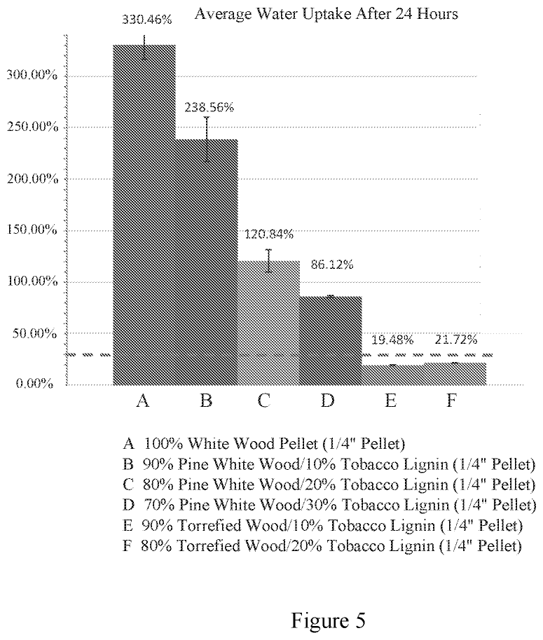

The torrefied pellets displayed extreme hydrophobicity. More hydrophobicity is always observed when comparing torrefied wood to white wood but eventually torrefied wood does disintegrate over time. FIGS. 4 and 5 show that both pellet compositions (10 and 20% extract) absorbed less than 30% water and retained their structure (see FIGS. 18-23) after 24 hours.

D) Absolute Density Tests:

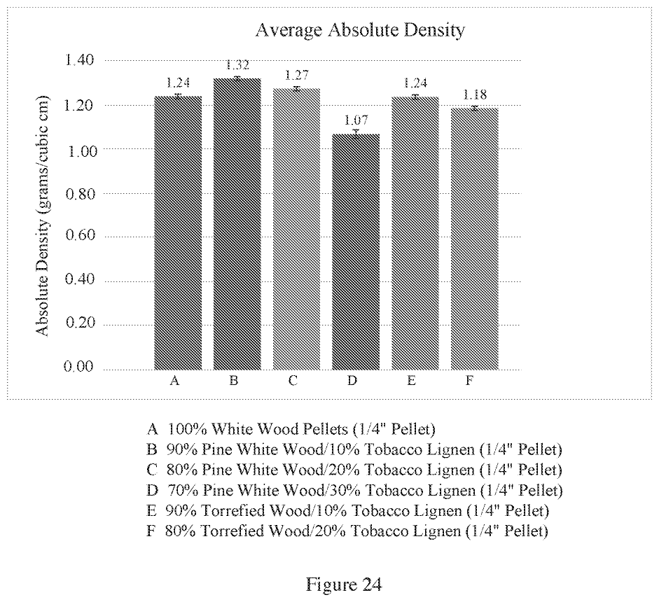

FIG. 24 displays the absolute density results. This test was conducted to show any differences in pellet density and if any density was gained or lost with extract concentration. The two sample sets that used the same compression ratio (white wood and 10% or 20% extract used a 5, torrefied wood and 10 or 20% extract used a 2) indicate that as extract binder inclusion goes up the absolute density decreases. However, the density does not account for the added energy density of the extract and pellet as a whole as with torrefied wood/extract pellets.

1. A method for producing an agglomerated solid bio-material, the method comprising:
providing a particulate torrefied wood mass, a biochar, or a comminuted wood mass;
providing a melt-flowable particulate extract from an organosolv pulping process;
blending the particulate torrefied wood mass, the biochar, or the comminuted wood mass with the melt-flowable extract to form a blended mixture wherein the particulate torrefied wood mass or the comminuted wood mass is the primary component; and
densifying the blended mixture under pressure at a temperature of at least approximately 38° C. (100° F.) to form the agglomerated solid material.

2. The method of claim 1 wherein the agglomerated solid material is an extrudate, a pellet, a briquette, or other geometrical shape produced with conventional densification equipment.

3. The method of claim 1 wherein the particulate torrefied or carbonized biomass where the comminuted wood mass comprises approximately 50 to 99% by weight of the blended mixture.

4. The method of claim 1 wherein the melt-flowable extract exhibits hydrophobic characteristics.

5. The method of claim 1 wherein the torrefied biomass or the biochar can be pelleted using lower compression ratios compared to standard practices for white wood pellets.

6. Method of claim 1 where the melt-flowable extract significantly reduces the fines that are generated at the pellet mill or other densification device.

7. The method of claim 1 wherein the densification occurs in a pellet mill and the agglomerated material comprises pellets or other solid shapes produced by densification, compaction, bricking or extrusion.

8. The method of claim 1 wherein the agglomerated solid biomass comprises torrefied wood and a melt-flowable extract content of between approximately 1 to 50%.

9. The method of claim 1 wherein the melt-flowable extract exhibits hydrophobic characteristics and provide such characteristics to the agglomerated solid material.

10. An agglomerated biomass comprising:
a biomass component, and
a melt-flowable extract from an organosolv process wherein the extract comprises approximately 50 to 99% of the agglomerated blend mass.

11. The agglomerated biomass of claim 8 wherein the extract exhibits hydrophobic characteristics and provides such characteristics to the agglomerated wood mass as a whole.

12. The agglomerated bio-mass of claim 8 wherein the agglomerated wood mass is either a pellet, a briquette or other shape produced by extrusion or densification techniques.

13. The agglomerated biomass of claim 8 wherein the wood component is a torrefied biomass.

14. The agglomerated biomass of claim 8 wherein the wood component is a biochar.

15. The agglomerated bio-mass of claim 11 wherein the torrefied biomass comprises wood dust, ground wood, agricultural waste dust, ground agricultural waste, torrefied and ground biomass, hydrothermal carbonized and ground biomass, dried algae, charred biomass by thermal processing or combinations thereof (either dry or wet process).

16. The agglomerated biomass of claim 8 wherein the melt-flowable extract comprises approximately 1 to 50% of the agglomerated biomass.

17. The agglomerated biomass of claim 8 wherein the agglomeration is accomplished by the use of other densification methods such as briquetting, extrusion, bricking, balling of both processed and torrefied biomass can be greatly enhanced using MFE as the key blend ingredient to develop enhanced physical properties especially hydrophobicity.
